(19) United States
(12) Patent Application Publication
(10) Pub. No.: US 2026/0268262 A1
(43) Pub. Date: Sep. 10, 2026

(54) SYSTEMS AND METHODS FOR GEOFENCE-VERIFIED QUALITY ASSURANCE OF RETAIL DISPLAYS

(71) Applicant: PicPocket Labs, Inc., Austin, TX (US)

(72) Inventors: Wolfram K Gauglitz, Austin, TX (US); Josha LeBeau, Kansas City, MO (US); Haden Judd, Tokyo (JP)

(73) Assignee: PicPocket Labs, Inc., Austin, TX (US)

(21) Appl. No.: 18/873,233

(22) PCT Filed: Jun. 8, 2023
(86) PCT No.: PCT/US2023/024883

§ 371 Date: Dec. 9, 2024

Related U.S. Application Data
(60) Provisional application No. 63/350,399, filed on Jun. 8, 2022.

(51) Int. Cl. G06Q 10/0639; G06T 7/00; G06V 10/75

(52) U.S. Cl. CPC G06Q 10/06395; G06T 7/0002; G06V 10/751

(57) ABSTRACT

A networked platform is provided for managing and verifying installation of retail displays at retail locations. The platform includes a software application provided on networked computing devices, a database containing project information including retail locations, administrative and retail accounts, and status of the shipping and installation of the retail display. A retail account on a mobile device can be used to verify proper installation of the display, where the mobile device includes image capture and location-sensing functions. Verification includes capturing an image of the installed display using the mobile device, comparing the captured image to a standard image of the display, and comparing the location of the mobile device when capturing the image to a geofence associated with the retail location, thus verifying both location and appearance of the display.

### CROSS-REFERENCE TO RELATED APPLICATION(S)

The present application relates to and claims priority from U.S. Provisional Patent Application Ser. No. 63/350,399 filed Jun. 8, 2022, the disclosure of which is incorporated herein by reference in its entirety.

### FIELD

The present disclosure relates to a networked, secure, geo-based system and method that facilitates the provision and verified installation of retail displays in store locations, namely, improved tracking of shipments of such retail displays and verification of their timely and proper setup in disperse retail locations.

### BACKGROUND

Driving foot traffic to store locations is the lifeblood of retail-it is what promotes product sales and allows retailers and brands to develop relationships with their customers. In retail sales establishments (e.g. department stores, specialty stores, boutiques, and the like), many brands design (or have designed for them) merchandise displays or so-called “pop-up” displays (retail signage) to promote brand awareness and attract the attention of customers to specific products, brands, or advertising campaigns.

These displays are generally constructed out of, or may include, cardboard, plastic, banners, metal structures, etc. In some cases, in-store advertising displays may be made from the very product that the brand is looking to draw attention to. As one example, a product that is sold in distinct red, white, or blue cartons could be stacked in a manner such that the overall pattern evokes the American flag. Other examples of retail merchandise displays could include, e.g., a scale model of the Millennium Falcon or Imperial AT-AT walker to promote Star Wars products, or a life-size stand-up cardboard cutout of a character or mascot associated with a brand or with a product being sold.

Some in-store advertising displays may also be interactive in nature. “Digital brand activation” and “retail-tainment” are terms used to describe immersive, interactive brand experiences that occur in-store, and may be experienced in person through a consumer's mobile device (most commonly smartphones, but they may also be experienced using tablets, wearable devices, etc.). Interactive advertising may also be achieved using video displays that allow for consumer input, such as touchscreens and keypads. Such in-store, experiential marketing activities provide an opportunity for consumers to engage with a product in the hopes of driving brand awareness, customer loyalty, and ultimately, sales.

Except for very large companies, most businesses do not maintain an in-house group dedicated to designing and building such merchandise displays. Instead, it is typical for many companies to work with a consumer packaged goods company to develop permanent, semi-permanent, or temporary advertising displays. These displays may be static, dynamic (e.g. having motors that move certain features or having dynamic lighting components), and may be designed as shelf, floor, or end-cap displays. Several such companies exist in Bentonville, Arkansas, where there is a focus on supporting brick-and-mortar retail stores. One such design-centric company is called Dare Devil Display Works (@daredevildisplay), whose range of work product can range from just tens of dollars for very simple displays to thousands of dollars for more complex displays. The more expensive and sophisticated displays may incorporate such features as video displays (which may be interactive via a touchscreen or keypad), mechanically animated components, network access for consumer interactivity and/or company-based remote interaction/configuration of display features, etc.

In a typical sequence for conceiving, designing, and implementing an in-store advertising display, a design company consults with the brand to come up with a display concept and the features it will include. Once the design is approved by the commercial client, the design company will then build the displays, which may number in the thousands for large advertising campaigns. The displays are then shipped to individual retail store locations. Once the displays are delivered, an on-site retail execution team (which may be the retailer itself or a local contractor) is tasked with preparing and installing the display to the satisfaction of, and specifications provided by, the design company.

One shortcoming of conventional retail-execution activities is that there is very little transparency or visibility throughout the process of shipping and setting up in-store advertising displays. Typically, only the design services company and the shipping firm (e.g., FedEx, UPS, USPS, etc.) know that a package has been successfully shipped to a retailer. And, whereas the retail storefront and the shipper may know when a display package was delivered, the retail execution teams responsible for setting up the in-store displays either have to be notified that the display shipment has arrived by the store's warehouse/receiving department, or rely on the design services company (the sender) to inform them that the display has arrived.

Because many such retail advertising displays are often part of nationwide advertising campaigns, timing of their in-store setup can be critical in order for the campaigns to generate the best return on investment. For example, such displays may be associated with a new product launch, a particular holiday, or the like. Verifying receipt of shipped displays by a large number of geographically diverse retail locations, and coordinating their timely and proper setup, represents logistical challenges that can have direct economic impact on the efficacy of an advertising campaign.

Unfortunately, such displays sometimes go missing, are damaged in transit, may be missing an item/part, can be accidentally binned/trashed/forgotten, or may be installed in a substandard fashion that doesn't meet the design company's specifications. To achieve maximum intended consumer reaction to the advertising displays, the displays must be set up precisely how they were designed and intended to be installed. However, verifying the quality or accuracy of display setups at a large number of geographically disperse locations requires both a large amount of time-consuming direct follow-up and a degree of trust when relying on the word of the retail locations that they have received and set up the displays properly and at the designated time.

Both the brands that commission/pay for the displays and the design companies that design/construct/distribute them typically take some steps to verify and monitor the quality of the display installations. This is typically done by directly querying each location's retail execution agent to confirm receipt and setup of the display, and optionally asking these same agents to take a photo of the completed job. Direct inspection of the advertising displays by a design company or the brand owner is generally not feasible because of the amount of time, travel, and resources required to verify the status of each retail location. However, even reviewing what may amount to hundreds or thousands of individual photos, if provided, to verify the display setups is a daunting task and may not be feasible due to timing constraints. Further, it is a general concern that some setup verification photos may be shared among retail-execution agents and re-used from one store to another, thereby defeating the purpose of such verification.

Accordingly, it may be desirable to provide an improved and logistically efficient system and method that generates accurate verification of the quality of in-store advertising display setups over multiple geographically-disperse locations. Such systems and methods address and/or overcome at least some of the deficiencies or issues described herein above.

### SUMMARY

Embodiments of the present disclosure can provide systems and methods that facilitate tracking of shipments of retail displays and improved verification of their proper setup in disperse retail locations, based on a secure, restricted-use networked system and infrastructure. Such retail displays are typically produced by a design company working with a manufacturer or brand, and sent to retail locations to promote product visibility and sales. However, the distribution and setup of such retail displays may involve hundreds or thousands of geographically diverse locations, such that verification of shipment/receipt, and of proper and timely setup, of the displays at these retail locations presents a significant logistical challenge.

In various embodiments of the disclosure, a geofence-based method and networked system can be provided that facilitates direct communication between a retail display project administrator and the various retail locations that have agreed to set up the displays in their stores. A system application, or app, can be provided that facilitates communications and other functions associated with the delivery and setup of retail displays. This app can be provided on any of a number of types of computing devices including, e.g., PCs, tablets, smartphones, and the like. At least one copy of the app associated with a particular retail location can preferably be provided on a mobile device, such as a smartphone or tablet, that includes image-capture functionality (e.g., a camera) and location-awareness capabilities (e.g., GPS functionality or the like). Such functions are common on many smartphones and tablets.

The networked application can be provided with various secure user accounts, with different permissions and features accessible to different accounts based on the account types. For example, “Admin” (administrative) accounts can grant access to creators, owners, and/or administrators of an advertising project to create a project associated with a retail display, associate a display project with one or more retail locations, and provide communications with the retail location as needed. Retail accounts can provide access to the disclosed system to one or more persons at a retail location, receive messages and alerts, and receive/send other data associated with the shipment, delivery, and setup of a retail display at that location, as described herein.

This app can be accessed by both project administrators and personnel at the retail locations to help maintain a current status of the retail display and verify its being shipped, being delivered and set up at a retail location. The disclosed system and method can also provide automated confirmation that the retail display has been set up properly and at the intended location using a combination of image analysis (through comparison with a standardized image of the retail display) and location-based detection to confirm proper location of the retail display as described in more detail herein.

In some embodiments, Admin accounts and Retail accounts can access various functionalities of the system needed to perform their respective functions via a single distributed app, with permissions to access appropriate features in the app being determined by the account type. In further embodiments, the disclosed systems and methods can provide different apps to Admin accounts and Retail accounts that are tailored to the particular functions and permissions associated with each account type. A different Public app associated with Public accounts, as described below, can also be provided to perform functions associated with the Public accounts.

The networked system, including the associated app(s), can be configured to perform the following functions, among others: a) creation of a project for a particular retail display project by an Admin account; b) notification to a Retail location account that a display will be provided to it for installation; c) notification to the Retail location account that the display has been shipped; d) notification that the display has been delivered; e) notification by the Retail location account to the Admin account that the display has been received; f) notification by the Retail location account to the Admin account that the display has been assembled; and g) verification of the proper assembly/setup of the display at the retail location, at which point the display project at a particular retail location can be said to be successfully completed. The app can also be configured to provide instructions (or links thereto) and/or communications between Retail and Admin accounts to facilitate proper setup and installation of the retail display.

Verification by a Retail account that a display has been properly set up can be performed by a mobile device associated with the Retail account. The mobile device can obtain an image of the installed retail display, and the app can be configured to perform an automatic image comparison between this image and a standardized image of a properly-configured retail display, where such standardized image can be stored in a database in the networked system that is associated with the retail display project. The verification procedure can also include location verification, whereby the location of the mobile device when the image of the installed display is captured is compared to a predetermined location or area (e.g., a predefined geofence) associated with the particular retail location. The predetermined location or geofence may optionally be precisely defined to specify a particular portion of the retail location where the retail display should be installed.

The image verification process can be configured to provide an indicator to show if the retail display is set up properly based on one or more images of it captured by the mobile device. An acceptable installation of the display can be determined by an appropriate level of image matching with the standardized image. The app can be configured to provide instructional prompts (e.g. words and/or images) on the mobile device to facilitate obtaining of an image of the installed display that is suitable for image-matching verification. Such prompts can include, e.g., an overlay of the standardized image with a live camera image on the mobile device, such that the two images can be aligned on the mobile device display to improve the image-matching process. Automatic lighting and/or color correction can also be provided by the app to facilitate the image matching process.

The level of matching can be provided in any of several ways including, e.g., a single positive indicator for a satisfactory match (e.g., a green light or a checkmark displayed by the app, or a numerical match parameter that exceeds a predetermined criterion), and a negative indicator (e.g. an X, a red icon, or the like) for an unsatisfactory match. The location-sensing function of the mobile device can also be used to verify that the captured image of the installed display was obtained at a predetermined location or within a predetermined area associated with the retail location.

In some embodiments, the app can be configured to allow the mobile device to obtain additional images of the installed display to repeat the verification process, and/or to send such obtained images to an Admin account to allow manual verification and approval of the installation by a user of an Admin account. The app can also be configured to indicate the status of the installed retail display, such that an approved match can indicate that the display installation is successfully completed at that retail location.

The app can also be configured to provide various notifications and prompts to both the Admin account and Retail account including, e.g., indications that the retail display will be and/or has been shipped from a source to a retail location, that the display has been delivered to and/or received by the retail location, that the display is in the process of being installed, and/or that the installation has been completed and/or verified. For shipping and delivery purposes, the app can optionally be provided with shipping data (e.g. a tracking number) to facilitate identification of the shipment progress.

The app can also be configured to provide time-based notifications and prompts to help ensure that the display installation proceeds in a timely manner. Such prompts can include alerts if a shipment has been delayed or lost in transit, if receipt of a delivered shipment has not been acknowledged by a user of the Retail account at the retail location, and the like. Prompts or reminders can also be provided to the Retail account if the display installation has not been started and/or completed within a predetermined timeframe.

The systems and methods can further organize information associated with a single display project involving multiple retail locations and/or a plurality of different displays to be installed at a single retail location. Such information can assist both the administrators of the retail advertising projects and the retail locations to efficiently track and review the status of multiple display installations. For example, the Admin account can be provided with a display of all display projects and their statuses at a single retail location, a list (with statuses) of retail locations for a single display project, and the like. Similarly, the Retail account can be provided with information identifying the progress and status of all displays to be installed at a single location and/or at all locations of a retail chain of stores, and the like.

In still other embodiments, the systems and methods can further provide “Public” accounts for the app to independent third parties to verify the continued and proper appearance of a display at a particular retail location after the installation is complete. Such Public accounts can display alerts on a mobile device, when requested by an Admin account, for a third-party user associated with a Public account to obtain images of the retail display at any time after the initial display installation is completed. This can provide the Admin account with verification (using both image-matching and location-based criteria) that the display is still present and installed properly at the retail location. The app can be configured to provide certain rewards to third-party users of the Public accounts for obtaining such post-installation verification data. These rewards can include, e.g., monetary awards, discounts on products or services (e.g. those associated with the display's advertising campaign), and the like.

### BRIEF DESCRIPTION OF DRAWINGS

Further objects, features and advantages of the present disclosure will become apparent from the following detailed description taken in conjunction with the accompanying figures showing illustrative embodiments, results and/or features of the exemplary embodiments of the present disclosure, in which:

FIG. 1A is a screenshot of an exemplary app home page in accordance with embodiments of the disclosure;

FIG. 1B is a screenshot of an exemplary app settings page;

FIG. 1C is a screenshot of an exemplary confirmation notification in the app when a user elects to log out of their account;

FIG. 2A is a screenshot of an exemplary app page showing information relating to shipment of a retail display to a particular retail location;

FIG. 2B is a screenshot of the app page of FIG. 2A indicating that the retail display has been shipped to a particular retail location;

FIG. 2C is a screenshot of the app page of FIG. 2A showing a pop-up alert with tracking information for the shipped retail display;

FIG. 2D is a screenshot of the app page of FIG. 2A indicating that the retail display has been delivered to a particular retail location;

FIG. 3A is a screenshot of the app page of FIG. 2A showing a pop-up alert indicating details of delivery of a retail display to a particular retail location;

FIG. 3B is a screenshot of an exemplary app page including a prompt to a Retail account to obtain an image of the retail display shipment received at a particular retail location;

FIG. 3C is a screenshot of an app page showing an accept/decline option for the image of the delivered shipment obtained following the prompt in the screenshot of FIG. 3B;

FIG. 3D is a screenshot of the app page of FIG. 2A showing confirmation of receipt of the display at the retail location using the image of the package shown in FIG. 3C;

FIG. 4A is a screenshot of an exemplary Retail account app page showing instructions for indicating commencement of the installation of a retail display at a particular retail location;

FIG. 4B shows the screenshot of FIG. 4A during the process for indicating commencement of the installation of the retail display;

FIG. 4C shows the screenshot of FIG. 4A after the commencement of the installation process has been confirmed, including a displayed timer for completion of the installation;

FIG. 5A is a screenshot of a Retail account app page on a mobile device showing the beginning of the visual verification process, with a standardized image of the retail display having variable transparency superimposed on a live camera image of the actual display and the two images not being aligned;

FIG. 5B is a screenshot of the Retail account app page of FIG. 5A, with the standardized and live images more closely aligned when following the instructions provided at the top of the screen;

FIG. 5C is a screenshot of the Retail account app page of FIG. 5A, with the standardized and live images even more closely aligned than in FIG. 5B;

FIG. 5D is a screenshot of the Retail account app page of FIG. 5A, with a displayed option to accept or decline a captured image of the aligned standardized and live images for verification of the display installation;

FIG. 5E is a screenshot of the Retail account app page of FIG. 5A, with a pop-up notification of an acceptable image-matching score between the standardized and captured images of the display installation and an option to finalize the image verification process;

FIG. 5F is a screenshot of a Retail account app page after the image verification has been finalized, showing an option to submit the captured verification image to the project database;

FIG. 5G is a screenshot of an Admin account app page indicating that installation of the retail display at a particular location has commenced;

FIG. 5H is a screenshot of the Admin account app page of FIG. 5G indicating that verification of the retail display installation has been completed;

FIG. 6A is a screenshot of the Retail account app page of FIG. 5A, with a pop-up notification of an unacceptable image-matching score between the standardized and captured images of the display installation and an option to retry the image verification process;

FIG. 6B is a screenshot of the Retail account app page of FIG. 5A, with a pop-up notification of another unacceptable image-matching score between the standardized and captured images of the display installation and an option to retry the image verification process or to use the captured image for manual verification;

FIG. 7A is a screenshot of an exemplary app page showing a search option for finding a particular retail location for a retail display project;

FIG. 7B is a screenshot of the app page of FIG. 7A showing a further search option for finding a particular retail location;

FIG. 7C is a screenshot of the app page of FIG. 7A showing a still further search option for finding a particular retail location;

FIG. 7D is a screenshot of the app page of FIG. 7A showing yet another search option for finding a particular retail location;

FIG. 8 is a screenshot of an exemplary app page showing the status of all display projects at a particular retail location;

FIG. 9A is a screenshot of an exemplary communications app page showing a telephonic assistance option for a Retail account; and

FIG. 9B is a screenshot of the communications app page showing a texting option among Retail and Admin accounts.

While the present disclosure will now be described in detail with reference to the figures, it is done so in connection with the illustrative embodiments and is not limited by the particular embodiments illustrated in the figures. It is intended that changes and modifications can be made to the described embodiments without departing from the true scope and spirit of the present disclosure as defined by the appended claims. It is also noted that any trademarks, trade names, or other proprietary identifiers shown in the figures are for illustrative purposes only, and do not imply any affiliation or agreement between the owners of such identifiers and the Applicant submitting the present disclosure.

### DESCRIPTION OF EMBODIMENTS

Embodiments of the present disclosure can provide a secure, restricted-use networked system and infrastructure that facilitates tracking of shipments of retail displays and improved verification of their proper setup in disperse retail locations. Such retail displays are typically produced by a design company working with a manufacturer or brand. However, the distribution and setup of such retail displays may involve hundreds or thousands of geographically diverse locations, such that verification of shipment/receipt, and of proper and timely setup, of the displays at these retail locations presents a significant logistical challenge.

In various embodiments of the disclosure, a geofence-based method and networked system can be provided that facilitates communication directly between a central administrative account (e.g., an account controlled by the display's brand or design company, hereinafter referred to as the “Admin account” or “Admin”) and the various retail locations that have agreed to set up the displays in their stores (with each retail location hereinafter referred to as a “Retailer”). Various stages of the display shipping and setup process can be tracked for each retail location, with options for direct communication and automated setup quality verification provided for each display to be located at each retail location, as described in more detail below.

The communication and project tracking can be performed using a conventional networked application that may be installed on a smartphone, a tablet, a PC, or the like. In some embodiments, two versions of the networked application can be provided in the exemplary networked system described herein: an Admin app version for use by the company or other provider of the display(s) being sent to retail locations (e.g., the administrative side), and a Retail app version for use by one or more users located at each retail location where the display will be assembled and displayed (e.g., the retail side). For verification of the proper setup of a display, it is preferable that at least one instance of the Retail app be installed on a mobile device (e.g. a smartphone or a tablet) having image capture capabilities and network connectivity.

One or more conventional networked servers, and associated databases, can be provided in communication with the various networked devices running the system apps. The databases can be used to store various information relating to functions of the disclosed system, such as user account registrations and security credentials, information specifying project details and associated user permissions, geofence data relating to retail locations, various forms of data generated during the use of the system by various participants, etc. These functions and features are commonly used in conventional networked systems that employ distributed applications among users.

The general stages of providing a retail display to a retail location, any or all of which may be tracked and/or processed by the networked system, include: a) notification to a retail location that a display will be provided to it for installation; b) notification to the retail location that the display has been shipped; c) notification to the retail location that the display has been delivered; d) notification by the retail location to the admin that the display has been received; e) notification by the retail location to the admin that the display has been assembled; and f) verification of the proper assembly/setup of the display at the retail location, at which point the display project at a particular retail location can be said to be successfully completed.

Tracking all of these steps to ensure that a display unit is delivered, received, and set up at a particular retail location can be a logistical challenge, particularly in view of the large number of displays that may be sent out to geographically disperse locations for a typical advertising campaign. Further, the various steps to be tracked and the numerous techniques for communication available can further complicate administration of a display-based advertising campaign. Accordingly, embodiments of the present disclosure provide a comprehensive administrative system that improves the efficiency and accuracy of the various steps listed above.

Access to both the Admin app and the Retail app (at each retail location) can be limited to authorized users through conventional secure accounts provided by and registered on the network system. For example, general access to the apps by administrative personnel and by retail employees can be secured using conventional online account security methods, such as requiring a username and password to access the apps. In some embodiments, other secure access methods may be required to access the apps instead of or in addition to a username-password combination. Such methods may include biometric techniques (e.g. fingerprint scanners or facial recognition), two-factor authentication (TFA), and the like. Authorization and recognition of valid accounts, including creation of new accounts, may be controlled on the administrative end of the network system, e.g., via the Admin app or a central system manager.

User accounts for the Admin app may be restricted to administrative personnel responsible for the distribution and setup verification of a particular advertising display at multiple retail locations. Multiple administrators may have access to data relating to a single advertising campaign and associated display distribution, or a single administrator may be provided with sole access to such data for a particular campaign. If multiple administrators are provided access to a campaign, then the network system may be configured to record and optionally display the particular user who enters or provides data or information relating to the campaign, including such features as shipping information, generation of alerts and reminders to retail users (e.g., registered users of the Retail app that may include retail employees, execution agents responsible for tasks relating to the setup of the advertising display, and the like), and approval of a completed display installation.

Similarly, one or more retail execution teams or agents associated with on-site preparation of an advertising display (e.g., retail employees or retail users) may be provided with accounts at a particular retail location that is receiving and setting up the display.

Multiple users may be desirable at a single retail location because separate employees at the location may be tasked with receiving shipments, delivering received display packages to other employees for assembly, and actually setting up the displays. Thus, one or more retail user accounts for the Retail app may be associated with each retail location, and the network system can be configured to track multiple displays (or “projects”) for different campaigns that may be sent to a single location. As with the administrative accounts, the Retail app may be configured to identify the specific retail user who enters particular information into the Retail app, and also direct certain alerts to particular retail users at a location who are responsible for different aspects of the project.

Both the Retail app and the Admin app can include options as part of the user interface to allow for alternative or additional means of communication between the admin and retail sides for a project. Such options can include, e.g., entry of a phone number for a retail office, user, or department for telephonic communications, entry of a user's cell phone number for text messaging, and/or entry of an email address for communications by email. One or more of these various communication paths may be associated with each user account (Admin or Retail) to allow for user-selected or automatic communication options as desired for a project.

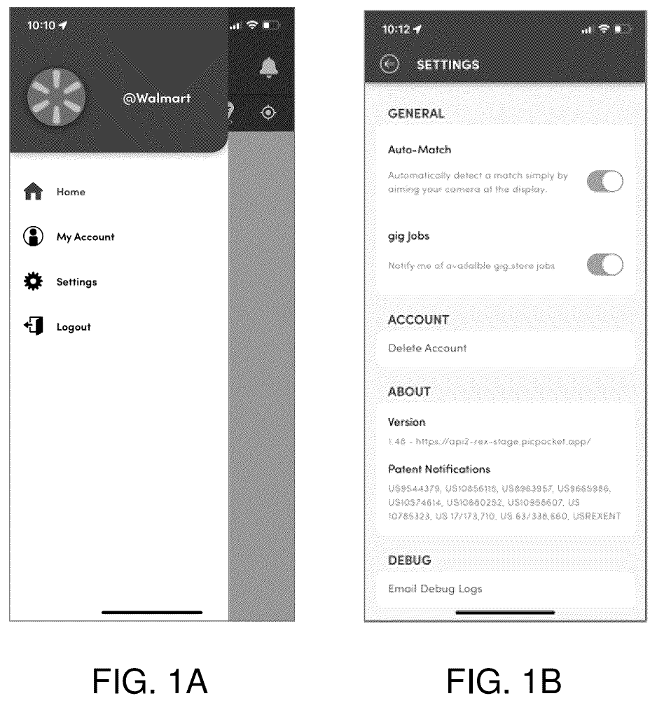

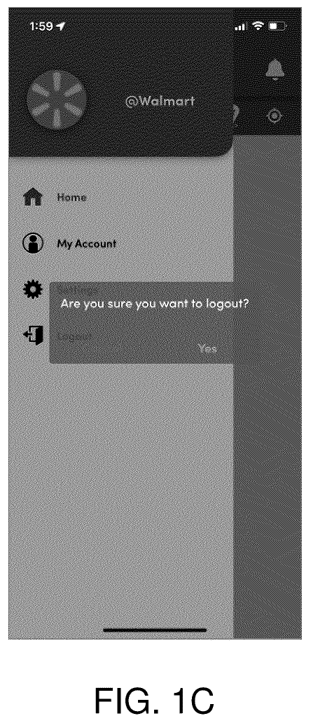

A screenshot of an exemplary Retail app home page is shown in FIG. 1A. A retail location can be shown at the top of the home screen, and can be customized by the network system to reflect the retail location associated with each retail user account. The exemplary Settings page screenshot shown in FIG. 1B can include any Retail app options that the administrators may wish to provide to retail users. FIG. 1C shows a screenshot of a confirmation page when a retail user selects the Logout option from the home page of the Retail app. Although logging out of the Retail app can close the app on the retail user's device, the Retail app can be configured to provide pop-up alerts or other indicators on the device to notify the retail user when a message or reminder is received via the network system relating to a project, even when the main Retail app is not running. Such alerts are commonly used for many general smartphone apps, and can ensure that a retail user doesn't miss any relevant reminders, communications, or other notifications related to a project even when they are not actively logged into the Retail app.

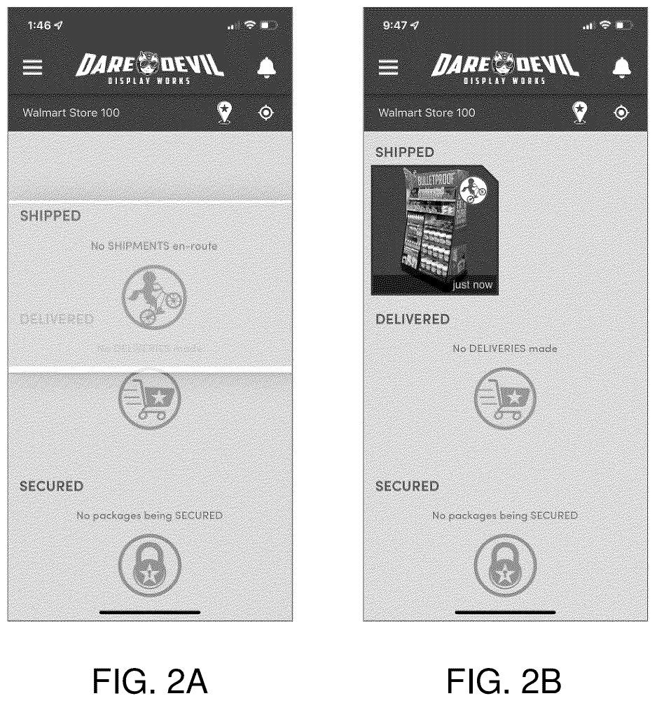

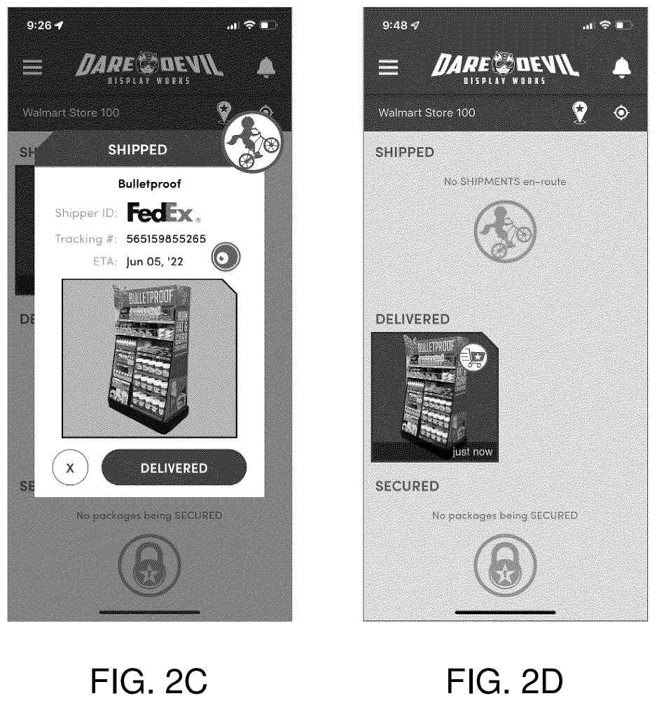

An advertising project begins essentially with shipment of a display from an administrator (e.g., a display design company, or another company or group that is tasked with distributing the manufactured advertising displays to retail locations) to one or more retail locations. A general status menu can be provided in the Retail app to indicate the progress of one or more projects. For example, the screenshot shown in FIG. 2A shows categories for Shipped, Delivered, and Secured, relating to the shipping of a display to a particular retail location (which is identified at the top of the screen). In this figure, no shipments are currently en-route to Wal-Mart Store #100 (Shipped), no shipments have recently been delivered (Delivered), and no shipments are being held in secure storage waiting for an employee or retail-execution agent to act (Secured). There are certain other categories (or feeds), not shown in the screenshot of FIG. 2A, which may facilitate tracking of a project through completion, including but not limited to In-Progress and Completed. Additional feeds/categories may be added to the database and display screens in the Retail and/or Admin app to track other retail execution tasks, including certain tasks that may only be accessible to employees/workers who are physically on-site (as determined by location verification techniques, which are described in more detail below). In FIG. 2A, the Shipped option has been selected (e.g., its icon was long-pressed), and can be moved up or down in display order (prioritized) relative to the other categories. For example, some administrators may be more interested in any work that is In-Progress versus packages which have been Shipped or an accounting of what has been Delivered or Secured; accordingly, they may choose to prioritize the In-Progress category to appear first in their feed or task category list.

When an advertising campaign is being executed, it can begin with shipment of advertising displays to a number of retail locations. To coordinate and manage the flow of these shipments, the network system can provide a shipping alert to each retail location (e.g., to one or more retail user accounts associated with each location) via the Retail app. Specific shipping information for each display shipment being sent to each retail location can be entered into the network system using the Admin app. The network system can be integrated with a web Application Programming Interface (“web API”) for the particular shipping company used to identify and track each display shipment, including automatic alerts displayed via the Admin app and/or Retail app to indicate the shipping status and any milestones or events associated with each shipment.

For example, FIG. 2B shows a screenshot of the Retail app that shows a shipment notification, indicating that a display has been shipped to this retail location. This shipment notification generated by the administrative side (e.g., by an authorized user of the Admin app or by the shipper's web API) can include a graphical image of the display that is being shipped, as shown in FIG. 2B. The network system can also be configured to provide a retail user/account with an alert on their device to indicate that a shipment has been made, even if the Retail app is not currently running. Such alerts can prompt a retail user to open the app to be aware of the shipment and optionally obtain more details about the shipment.

The network system can be configured such that clicking on the shipment alert shown in FIG. 2B can bring up details of the shipment, including the shipping company, the tracking number, and an estimated delivery date, as shown in FIG. 2C. This information can be generated and/or by the web API of the shipping company and may reflect any shipping delays due to, e.g., weather or other factors.

The network system can optionally be configured to track the timing of each phase of the shipping process, from handing the shipment to a shipping company, to delivery at the retail location, to confirmation of receipt of the shipment by a retail employee. This shipment timing may be indicated as elapsed time from the moment the shipment has been picked up by the shipper and entered into its system to when it has been delivered at the retail location (e.g., by accessing the shipper's web API through the Retail app and/or the Admin app). Alternatively, the shipment timing may be indicated as a countdown timer, indicating the time remaining until delivery is expected at the retail location, based on the shipping company's estimate. This countdown timer may be helpful in alerting retail users as to how soon they can expect the shipment to arrive, and may further motivate them to act on taking receipt of these shipments and setting up the enclosed displays rather than waiting to be tasked to complete the retail signage job.

While a display shipment is in the shipped state, the Retail app can be configured with a button in the user interface (UI) to request an alert when the shipment has been delivered at the retail location. In another embodiment, a delivered alert may be automatically generated for one or more retail user accounts at the retail location. In yet another embodiment, the shipment status indicator shown in FIG. 2C can be provided with a Delivered button, where delivery of a shipment at the retail location can be manually entered by a retail user when the shipment arrives. In other embodiments, the Retail app and the Admin app can be configured to automatically indicate that the shipment has attained delivered status when the shipping company drops off the shipment (e.g., via the shipper's web API). Once a shipment has been confirmed as being delivered, the Retail and/or Admin app can be configured to display the shipment as having attained Delivered status, as shown in the screenshot of FIG. 2D.

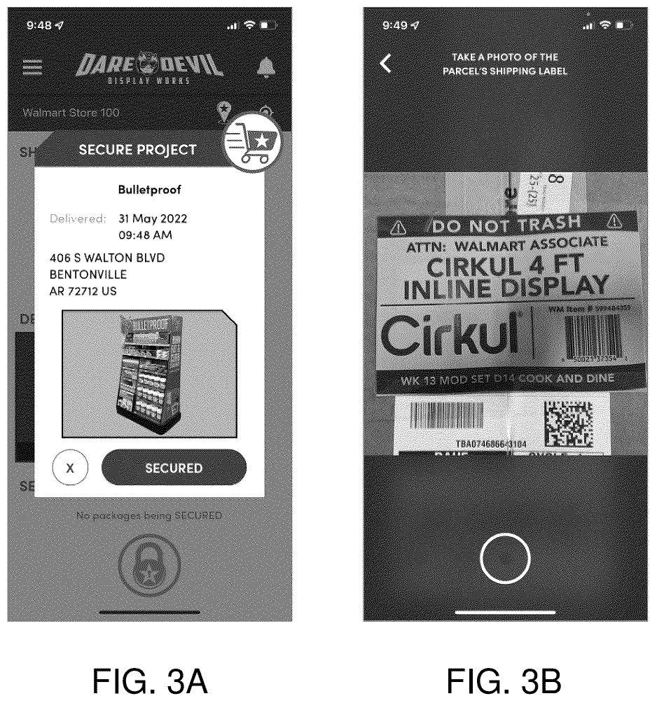

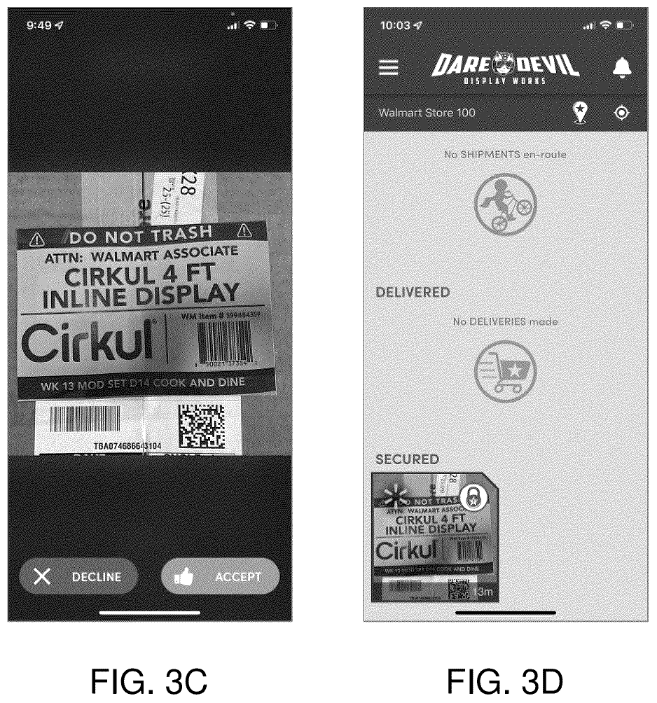

Once a display shipment has been delivered, the network system can be configured to indicate that the shipment has been secured (e.g., received and identified by a retail employee/user). Securing a shipment at a retail location can be confirmed via a pop-up window in the Retail app that can appear once delivery has been confirmed, as shown in FIG. 3A. This pop-up window can indicate the delivery time and location, and further be provided with a Secured button. Clicking on the Secured button by a retail user can confirm the status of the shipment as secured, to help ensure that the shipment has not been misplaced at the retail location and is in the hands of a responsible party, such as a retail execution agent or a particular retail user/employee.

The Retail app can optionally be configured to prompt the retail user to take a photograph of the actual shipping label on the secured package when the Secured status has been activated, as shown in the screenshot of FIG. 3B. The Retail app can also be configured to activate the camera of the retail user's mobile device to take the picture, and then provide an option to accept the image of the shipping label or decline it and take another picture. These options are shown in the exemplary screenshot of FIG. 3C. Once the secured status has been verified by a retail user as described herein, the shipment then appears as Secured in the Retail app and the Admin app, as shown in FIG. 3D. The secured status can be indicated by an icon showing the image of the shipping label, as shown in FIG. 3D, or alternatively it may appear just as an image of the actual display (e.g., as shown in FIG. 3A) or as another graphical image, or as any combination thereof. For example, an icon or tile may appear as multiple sequential images that include an abrupt shift or fading transition between images.

If a display shipment includes a number of separate boxes or containers, then a separate shipment/delivery confirmation can be provided for each package in the shipment. Further, the retail user may be prompted to take a picture of the shipping label for each package before a full shipment is confirmed as being secured. In this manner, the network system can efficiently confirm that a multi-package shipment is complete, and generate an alert if one or more packages of the shipment are missing. The alert can prompt the retail user to locate any missing packages of the delivered shipment that may have been misplaced at the retail location, so that the complete shipment can be verified as being secured.

The UI of the Retail app can be provided with a selectable option to indicate if there is visible damage to a shipped package. If damage is observed by a retail user or other retail employee, the retail user can select the “Damaged Package” option (not illustrated) and then be prompted to take one or more photos of the damage via the Retail app. A damage alert can then be provided by the network system to administrators of the advertising project, together with the images of the damage, via the Admin app. Subsequent actions taken to remedy the damage may depend on a number of factors, including the extent of apparent damage, the desired timing of the display setup, the shipper's damage policies, etc. For example, if a display shipment is damaged and setup timing is critical, a replacement shipment may be sent quickly to the retail location using an express delivery option. Because the advertising campaign administrators are likely familiar with the contents of the shipment package, they may be better positioned to assess the likely extent of damage to the display based on the appearance of the external damage to the package. The feature of having a nearly real-time alert and indication of package damage to the shipping party can provide more options for better handling any observed shipping damage in a timely fashion.

The Retail app can optionally be provided with a timer that begins counting when the shipment is confirmed as delivered, and records the elapsed time between delivery confirmation and securement confirmation at the retail location. This processing time may be used by the retail location and/or by the administrators to quantify the delivery efficiency at the retail location, and optionally hold retail users accountable for any undesirable delays in securing a delivered shipment.

Once a display shipment has been received and secured at a retail location, the final step is to set up the display in the store and verify that it has been set up properly. The timing of the display setup and presentation at a retail location may be subject to certain constraints. For example, a brand or product company may want the advertising displays to appear in-store on a particular day. Alternatively, they may want to merely have the display installed no later than a certain day, with early setup being acceptable. In either case, the Retail app may optionally be provided with pop-up alerts and reminders to indicate to the retail user(s) when the setup process should be completed.

Showing a display shipment as being Secured in the Retail app (e.g., the advertising display package may be available, in-store, in a designated storage area and ready to be checked out and assembled/installed) may help to create a sense of immediacy and urgency in the responsible retail employee(s)and/or retail execution agents to complete the task. In some embodiments, a timer (not shown) may be displayed in the Retail app once a display shipment has attained Secured status as shown in FIG. 3D. This timer may be represented as a countdown timer indicating how much time remains before the process of assembling the display and placing it on the retail floor (or other location) must be done. The timer may be displayed in terms of hours (and optionally minutes if precise timing is desired), as calendar days, or both. If the display is intended to be installed within a particular time period, then a first timer indicating the time remaining to the beginning of the desired setup time window can be shown, and a second timer indicating the deadline by which the installation must be completed, may be shown. The Retail app can be configured to show one or more timed pop-up reminders or alerts to begin the display setup process to one or more retail users associated with the advertising project at the retail location. Similar reminders/alerts may be provided to one or more project administrators through the Admin app, such that an administrator may be alerted to contact a retail user directly if the setup process has not been initiated in a timely manner.

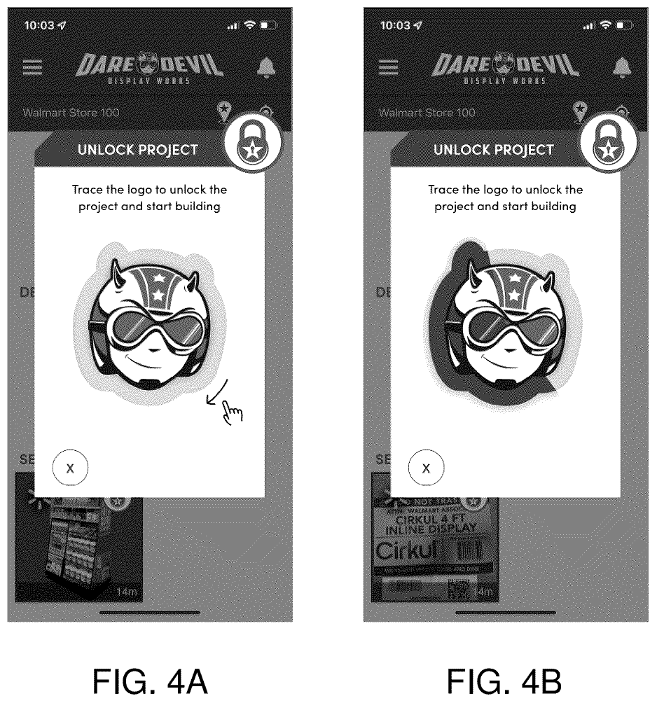

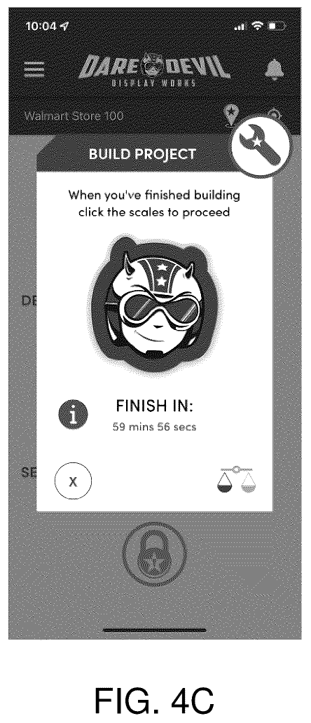

The setup process begins with an indicator on the Retail app that allows a retail user to begin the display setup process. This indicator can appear as a pop-up window in the app that requires input from the retail user, e.g., upon selecting or tapping the Secured (lock) icon shown in FIG. 3D that is associated with a particular display project. In FIG. 4A, the exemplary pop-up indicator appears as an icon that the retail user must encircle with their finger on the touchscreen to confirm that they wish to initiate, or “unlock,” the setup process when they are ready to assemble or otherwise prepare the display and place it in its desired location at the retail store. FIG. 4B shows partial completion of the input process, with the icon encircled about halfway around. Completion of the user input that unlocks the setup process is shown in the exemplary screenshot of FIG. 4C. The icon has been completely encircled by the retail user's input, and the display setup process has begun. Other retail user input criteria may be used to initiate the setup phase. In general, this input may involve a deliberate user action beyond merely a single button press or the like, e.g., a follow-up “are you sure?” confirmation or the like, to help avoid accidental startup of the setup phase through the Retail app. A timer may optionally be displayed at this point, indicating a desired deadline by which the display assembly should be completed and ready for verification. Such a timer is shown in the exemplary screenshot of FIG. 4C, together with an icon (here, a set of scales) that may be selected by the retail user to confirm that the display assembly has been completed.

In some embodiments, the Retail app may provide access to documents and/or videos detailing the assembly process for the display upon initiation of the setup phase. Such instructional aids may be helpful to the retail user/assembler, especially if a display has multiple parts and/or requires components to be handled in a particular order. The Retail app can also be provided with various means of direct communication with a person on the administrative end of the project, as detailed below, in case any questions or issues arise during assembly of the display.

Once the display has been assembled and placed in its retail location, as confirmed, e.g., by tapping the scales icon in FIG. 4C, the critical verification process begins. It is desirable to verify that the full display has been properly assembled and set up at each retail location, such that the advertising campaign can achieve its desired impact on consumers. Timely verification that the display is assembled and on location may also be important for coordinated or time-sensitive advertising campaigns. Conventional verification methods commonly used, such as phone calls or emails, may be easily falsified, e.g., if a retail employee forgot to assemble and locate a display and merely confirms that they have done so to avoid negative repercussions. Also, a retail display may have been improperly assembled, and administrator verification of proper assembly and appearance of the display at a large number of retail locations can be logistically challenging, and may not even be possible if the timing of the display setup is critical and many retail locations are participating. Accordingly, embodiments of the present disclosure provide a system and method that includes verification of the timeliness and objective accuracy of the display setup, including verification that the display being verified is actually located at the proper retail location.

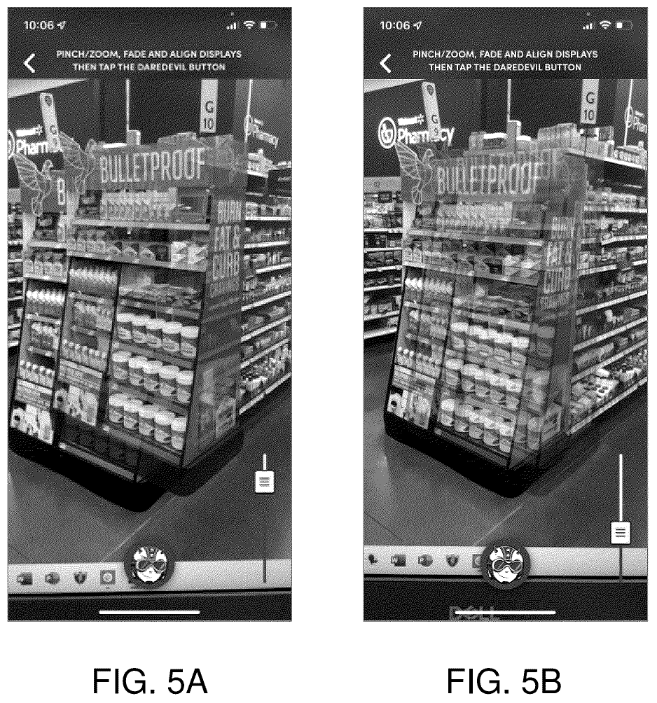

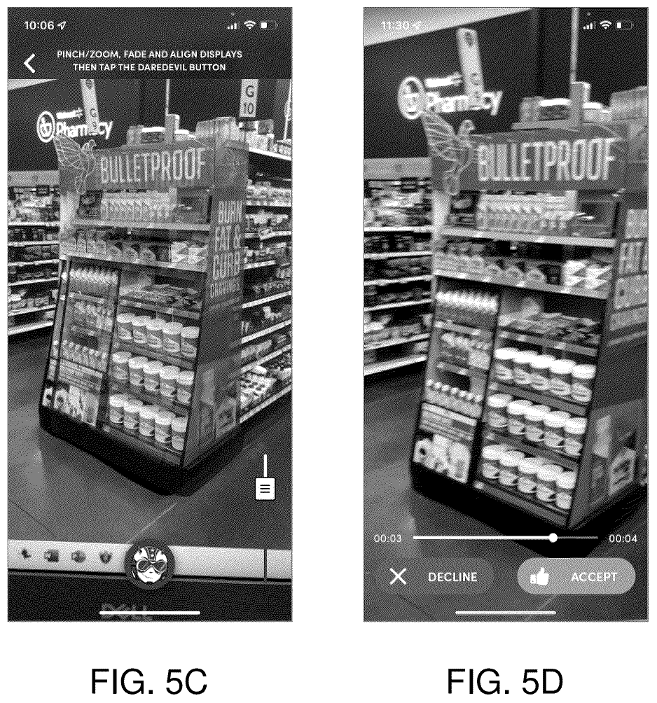

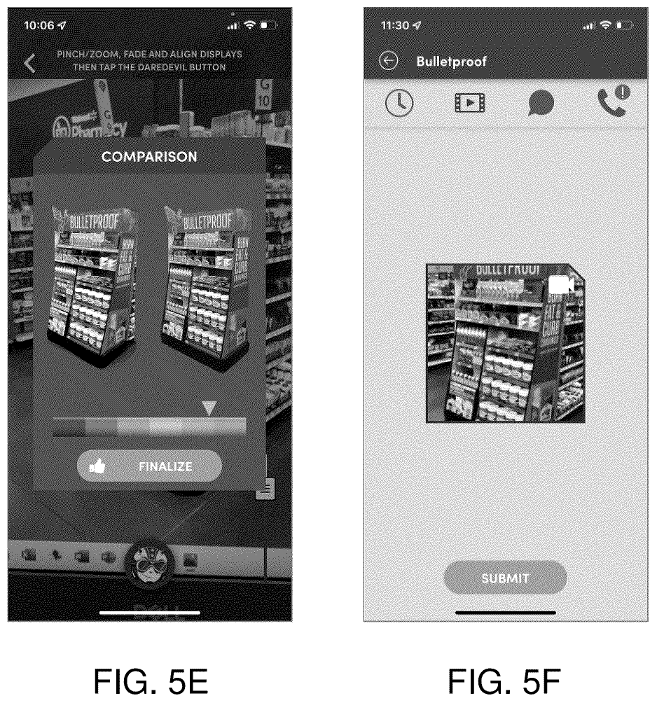

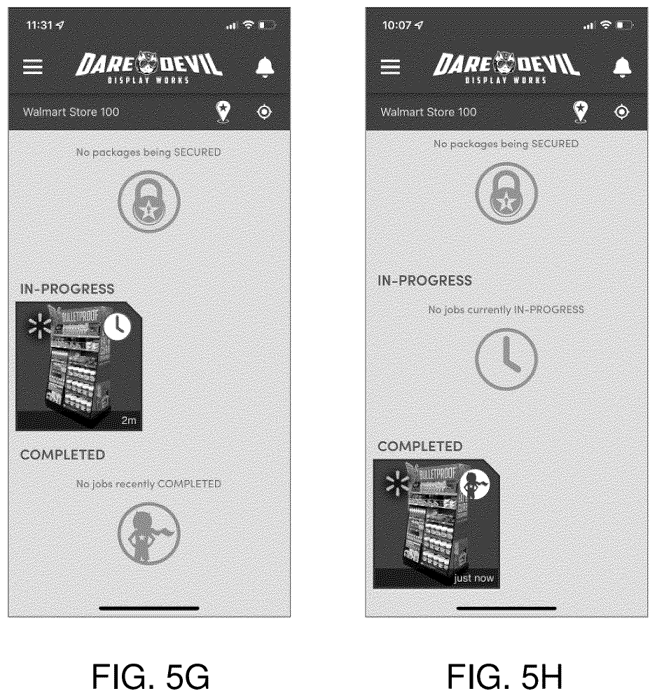

When the display setup is completed, as confirmed by retail user input, the display of the Retail app can shift to a camera view to initiate the verification process. The camera field of view can be provided with a superimposed, partially transparent reference image of a properly assembled display, together with on-screen messaging/instructions advising the retail user how to proceed, as shown in FIG. 5A. The displayed reference image can be pinched/zoomed to make it appear slightly larger or smaller on the screen, and a fader button/bar can be displayed on-screen and used to vary the percentage transparency of the reference image. The on-screen instructions can direct the retail user to use the on-screen controls and adjust the camera position/angle until the actual completed display aligns closely with the superimposed reference image on the camera display, with the fader function optionally being used to facilitate alignment of the images. A sequence of progressively improved alignment of the actual display with the reference image, as shown in the camera view of the Retail app, is shown in FIGS. 5A-5C.

For this alignment procedure, the Retail app can also display a shutter button on screen; in FIGS. 5A-5C this shutter button is shown as a round logo at the bottom center of the screen. Clicking on the shutter button then displays the superimposed images on the Retail app screen, with buttons providing options to accept the superimposed images, or decline them to restart the image superimposition process over and take a better picture. These options are shown in the screenshot of FIG. 5D.

When the superimposed images are accepted by the retail user, a procedure based on computer vision algorithms is then used to objectively compare the captured image of the assembled display with the reference image. Image comparison can be performed using any known image comparison techniques, which may be tailored for this specific comparison purpose as described herein. For example, Apple's Vision SDK (or similar image-comparison software) may be used as a basis for comparing the actual and reference images of the display. During the comparison procedure, the borders of the actual display image may be detected and areas outside of the display itself may be cropped, with the cropped image then being compared to the reference image that can be pre-cropped to show only the reference display with no background.

Various details of the automated image comparison may be tailored explicitly for use in this retail-execution application to establish a percentage match or overall score between the reference and snapshot images of the display. For example, an algorithm can be provided that detects edges and corners of the photographed display image and performs a skew of the image to semi-flatten it into a rectangle, thus facilitating removal of background portions of the captured display image, e.g., the areas of the retail location visible around the display itself. An image comparison tool such as the Apple Vision SDK can then used to create a “FeaturePrint” of both the reference image and the modified snapshot image of the installed display. These FeaturePrints can then be compared to each other to obtain an objective similarity value between the reference image and the captured image.

An exemplary screenshot of the Retail app after the superimposed images have been accepted by the retail user is shown in FIG. 5E. The retail app can be configured to show separate views of the reference image and the captured image, together with a comparison score determined by the image comparison routine that was performed on the cropped images. In FIG. 5E, the image comparison rating is indicated by a triangular marker located along a gradient bar above the Finalize button. This comparison score may be displayed, e.g., as a bar that varies left to right as a red-orange-light orange-yellow-light green-green gradient, with colors toward the right end of the bar (green) indicating a better match, and red indicating a poorer match. Other ways of displaying the quality or score of the image matching procedure can be provide such as, e.g., a 0-100% numerical score or the like. This displayed matching score informs the user whether or not the correlation between the photographed display image and the reference image is sufficient to achieve an automatic approval of the display assembly. A predetermined threshold score or level for the image matching may be provided through the network system to only allow submission of the image if the match exceeds that threshold.

In some embodiments, further processing of the captured display image may be performed prior to the matching procedure to improve accuracy of the comparison. For example, the brightness level, white level, contrast, or other image characteristics may be detected using an automatic algorithm and adjusted to better match those properties of the reference image. Color levels of one or more portions of the captured image may also be matched with corresponding potions of the reference image to improve the captured image quality for more reliable matching to the reference image. Such image corrections can account for lighting differences between the reference image and the display image captured in the retail location.

If the image matching is determined to be sufficiently high by the comparison procedure, then a Finalize button can be displayed together with the comparison rating as shown in FIG. 5E. Upon selection of the Finalize button, the image of the assembled display taken by the Retail app can be displayed on-screen and submitted to the network system by the retail user, as shown in FIG. 5F. The submitted image of the assembled display can then be associated with the store-specific display project and uploaded to the network system database, where it may be accessed and viewed by administrators of the project through the Admin app, e.g., for reference or further visual confirmation that the project has been completed at that location. Upon submission of the finalized image (that meets the predetermined image comparison criteria), the retail user can be credited with having completed their job and the display project at that retail location can be moved from In-Progress status (shown in FIG. 5G) to Completed status (shown in FIG. 5H).

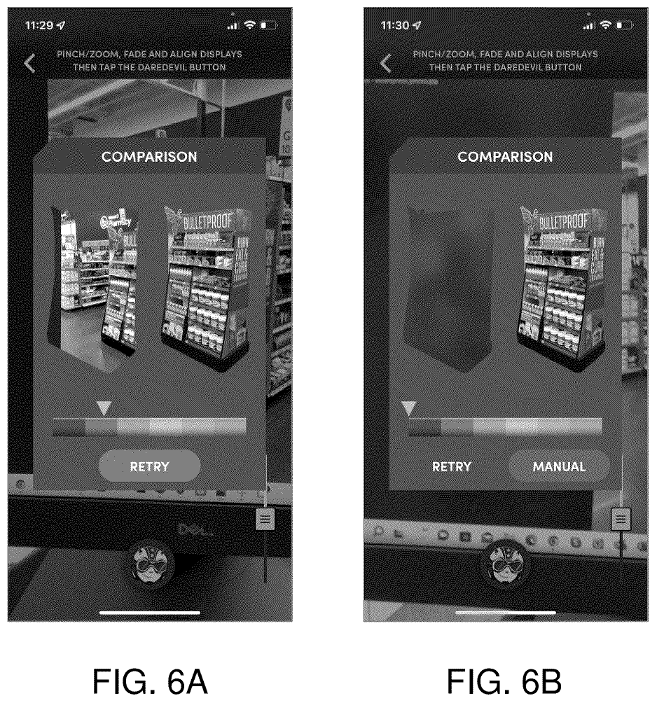

If the image comparison suggests that the assembled advertising display does not meet the preset image comparison threshold, a low comparison score may be indicated and the retail user can be presented with an option to Retry and capture a better superimposed image of the display, as shown in FIG. 6A. In FIG. 6A, the captured image shown on the left was poorly superimposed on the reference image, as indicated by the misalignment of the captured image with the reference outline. The Retry button, when selected, allows the retail user to repeat the image superposition and capture process until a satisfactory matching score is obtained, at which point the captured image may be submitted via the Retail app to complete the project.

If a preset number of captured images fail to meet the threshold image matching criteria (e.g., three attempts or any other predetermined number of attempts), the retail user may be given the option of submitting photos/videos of their work product manually so that captured images/video may be received by a project administrator and manually reviewed for approval. For example, an image comparison that fails to meet the threshold matching level is shown in FIG. 6B, where the captured image appears to be out of focus. Upon selection of the Manual button, the retail user may be prompted by the Retail app to capture one or more images (and/or videos) of the assembled display for manual submission to the network system. In one embodiment, the retail user may be prompted to submit one photo for each of frontal, left, and right perspectives of the assembled display. In another embodiment, the retail user may be prompted to submit a short video of the display that encompasses different views to provide an overall view of the assembled display for manual view, optionally together with still photos. The manual submission procedure can be presented as an option to the retail user, together with an option to retry the superimposed image capture, as shown in FIG. 6B.

When photos/videos are submitted manually by a retail user, the submission may be flagged via the Admin app to notify an admin for the project to manually approve or reject the assembled display. If the manual submission is rejected, the Admin app can be configured to allow the reviewing admin to provide written feedback on the manual submission, indicating any nonconforming aspects of the assembled display revealed in the manual submission, and optionally to provide graphical markups overlaying the manually-submitted photos and/or video to guide the retail user on how to remedy the mismatch so that the project will be approved. Optionally, the Admin and Retail apps can be configured to provide audio feedback from the admin to the retail user, e.g., in the form of a digital audio file, which may describe any changes/modifications the reviewing admin requires in order for the job to be approved. Such back and forth communication can continue until such time that an approval of the project is granted, which may include further submission of superimposed images by the retail user after appropriate changes to the assembled display are made.

In some embodiments, more advanced image capture techniques may be employed in the Retail app and network system to allow a retail user to simply aim their camera at the assembled advertising display, with computer vision capabilities configured in the Retail app to recognize the display in the camera's field of view, perform any needed adjustments or image transformations to match the camera image to the reference image, and determining a matching comparison automatically. This automated approach would not require the retail user to manually perform the pinch/zoom and camera positioning procedures to overlay the captured and reference images. This fully-automated matching procedure may be better suited for some advertising projects than others, and an option to use the automatic mode may be selectable by the retail user, turned on or off by a project administrator for a particular advertising campaign or a particular retail location, etc.

One critical aspect of verifying proper setup of retail displays for an advertising campaign is confirming that the display has been actually set up at the intended retail location. This location verification can avoid falsification of setup status at certain retail locations, e.g., by the sharing of display images among different locations of a particular retailer. Location verification of display setups can be achieved automatically using geofencing concepts that employ the location-awareness capabilities of a mobile device such as a smartphone or tablet that is running the Retail app. The most common system used for determining position of such devices is the global position system (GPS), which can provide detailed location coordinates of a GPS-equipped device for virtually any location on the planet. For example, a typical GPS system provided in a current mobile device can determine the device location to an accuracy of about 1 to 3 meters.

As used herein, a geofence refers to a virtual boundary that surrounds and defines a particular enclosed geographical area or region. Geofences may be arbitrarily created, e.g., by drawing the boundaries on an electronic mapping program, or they may be created by databases or numerical algorithms that result in a set of predefined geographical boundaries. A geofence may encompass a single contiguous geographical area, or alternatively it may be associated with two or more separate geographical regions, each enclosed and defined by its own virtual boundary.

The implementation of location verification in the network system includes defining a predetermined geofence associated with each retail location. U.S. Pat. No. 9,544,379 describes the definition and use of geofences to automatically verify the location at which capturing of media or other operations are performed by a location-aware mobile device. Such location verification may be integrated into the network system to provide confirmation that the display setup and quality verification are actually being performed at the specified retail location.

In some embodiments, the geofence associated with a particular retail location may be simply defined by a central location of the retail location, together with a radius that encompasses the location. In further embodiments, the geofence may be defined in more detail, e.g., to specify a particular area of the retail location or to encompass one or more specific areas of the retail location where the advertising display should be located. More precisely-defined geofences may be preferable, e.g., when displays are intended to be displayed somewhere within a general area such as, e.g., the entrance area of a retail location, a particular spot in a parking lot of the retail location, an outdoor location that may be proximal to but not within the actual retail store, etc.

The Retail app can be configured to detect the current location of a mobile device running the Retail app, and compare that with the relevant predefined geofence to automatically confirm the desired location of the display setup activities through the Retail app. The geofence can be persistent (e.g., time-independent), or it may be defined to only be active during store hours or when inventory is taken. Multiple geofences can be defined for an individual retail location for an individual project or for multiple projects located at a particular retail store. For example, separate geofences may be defined for the shipping/receiving area and for the public display area of a retail store, with individual steps of the project phases described herein requiring their own location verifications relative to their associated geofences. In some embodiments, the location verification may only be required generally during the display verification phase, to confirm that the image comparison procedures are performed at the designated location, whereas other projects may require more detailed location verification of different phases. The location parameters can be set individually for each project and/or retail location by administrators, e.g., via the Admin app.

Depending on predetermined account-level permissions, specific retail users may be limited to only being able to view activities associated with, or to participate in securement or assembly of, advertising displays at a specific retail location when they are physically located within the geofence associated with the retail location. This location verification can be automatically performed by the Retail app based on the detected location of the retail user's mobile device before allowing certain actions to be performed in the app, and provides an additional level of security to help prevent accidental or fraudulent activities involving the receiving and setup of an advertising display.

Failure of an operation initiated by the retail user through the Retail app to conform to the location requirements can create an alert or notification to the retail user and/or project administrator via their respective apps, and may prevent the operation from being completed/accepted by the system until the location issue has been remedied. Upon such notification, various communication means provided through the network system can be utilized to identify and correct the cause of the location nonconformance.

The Retail app and the Admin app can be configured to allow display of the status of multiple projects, with completed stages of a project also being accessible. The Admin app, for example, can be configured to allow an administrator to select individual retail locations for an advertising project to easily view the current status and history of a particular project (or of all pending projects) at that location.

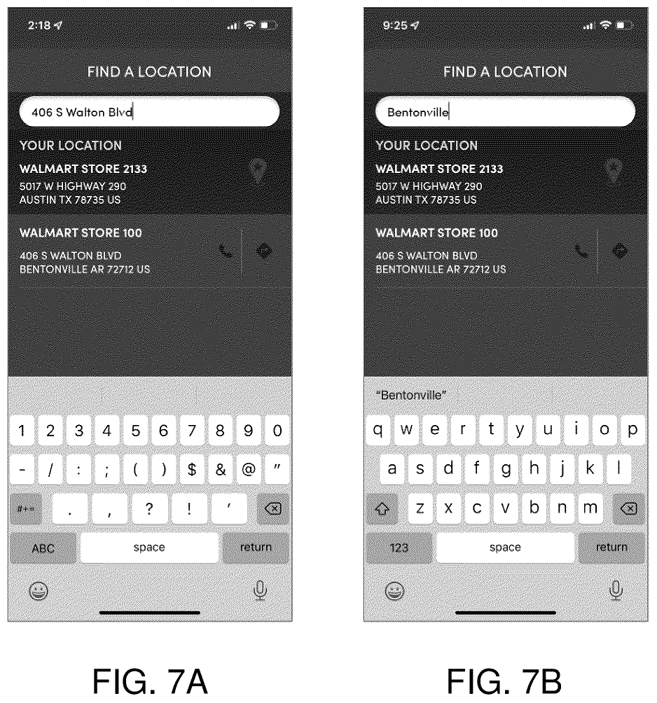

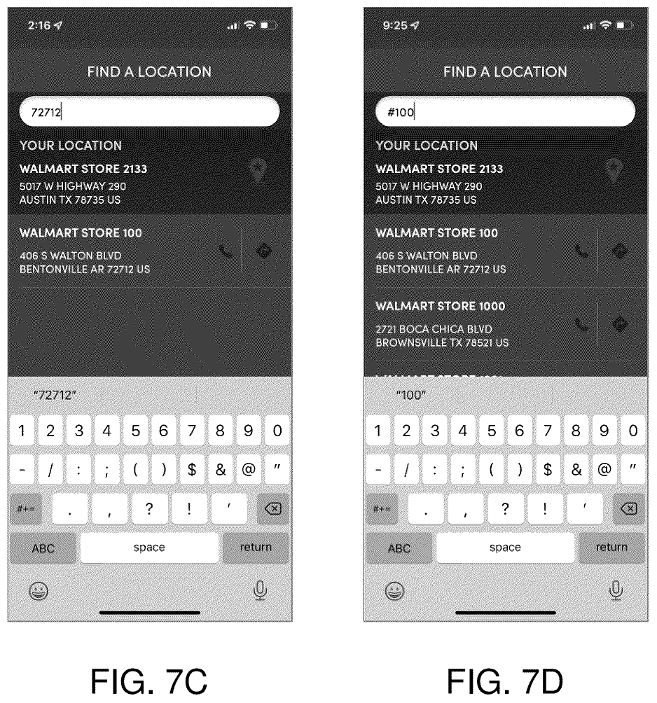

Individual retail locations participating in one or more advertising projects may be searched for within the Admin app using a search function. This retail search function may be based on criteria such as retail address, city or town, zip code, or store number, as illustrated in the exemplary screen shots shown in FIGS. 7A-7D, respectively. Other search criteria may also be provided in the Admin app such as, e.g., map-based searching to highlight and allow for selection of all retail locations participating in a project within a designated area on the map.

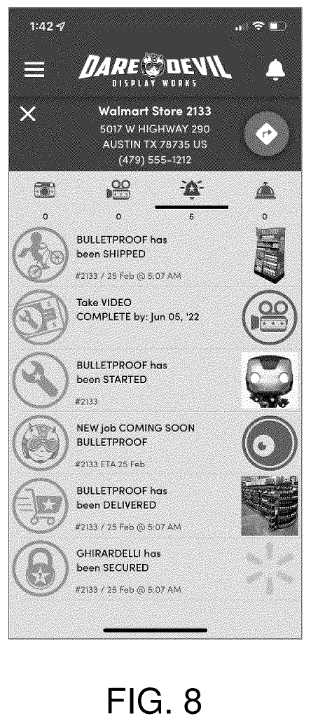

Selection of a particular retail location can bring up a display in the Admin or Retail app indicating the status of all projects associated with that location, an example of which is shown in FIG. 8. The Retail app may be configured to allow a retail user to view only the status of all projects at their particular retail site. Viewing of project statuses may be prioritized within the Admin and Retail apps as desired, with such display priorities being predetermined by the network system or optionally configurable by the retail users and administrators. For example, a project administrator or retail user may wish to prioritize display of shipped packages, secured shipments, projects having upcoming setup deadlines, or the like in their respective apps. Prioritizing in-progress projects by moving them to the top of a status display may be more important for retail users, whereas seeing which display projects have been completed at a particular retail location (e.g., over some time interval) may be of most interest to project administrators. Any setup projects that have an imposed time constraint that has almost expired or has not been met can be given display priority within the Admin and/or Retail apps, and may be accompanied by pop-up messages or other alerts within the apps to help ensure that the various projects are completed and confirmed in a timely manner. Selection of a particular project or status in the overview of FIG. 8, e.g., by tapping the icon to the left of the status indicator, can bring up a display of all events associated with that particular project.

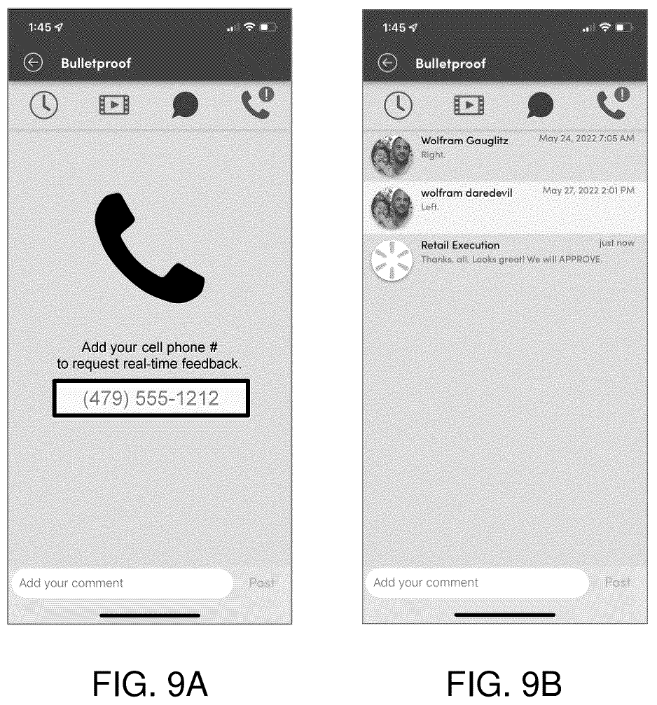

Various forms of contact information and means of communication between administrators and retail users can be incorporated into their respective apps. For example, the Retail and/or Admin app can provide a field for their respective users to enter one or more contact phone numbers, as shown in FIG. 9A. Other types of contact information may also be requested and associated with user accounts including, e.g., email addresses or additional phone numbers, including phone numbers identified as cell phones to allow for direct text messaging among users.

Communications among users may be performed outside of the network system and apps, e.g., by directly calling, texting, or emailing a user based on their provided contact information. In further embodiments, the Admin and Retail apps can be configured to incorporate communications between users directly. For example, selection of the text balloon icon at the top of a communication screen shown in FIG. 9A may initiate a texting dialog between a first app user and a second user associated with the messaging screen (where the second user may be selected through a directory provided by the app that may be location-specific with respect to available users, or where the second user may be a governing authority as it relates to approval of the work product). An example of in-app text communications is illustrated in FIG. 9B, where the history of the messaging between two users may be stored and accessed at a later date, as is done with conventional texting apps. Messaging conversations may also be location-specific and/or project-specific, so that communications relating to a specific project, user, and/or retail location may be easily located and reviewed if desired. Other communication methods may also be implemented within the apps, such as tapping on the telephone icon at the top of the communication screens shown in FIGS. 9A-9B to automatically dial the selected user to initiate a phone call.

A third, permission-limited version of the network system app (a “Public app”) can be provided to the general public (or subsets thereof), and configured with the ability to receive and perform photo/video requests of anything pertaining to typical retail-execution activities by third parties. Any participating party who has access to this feature within the app/service could make a request to registered third-party users of the Public app for a photo or video of a specific product, display setup space, or other retail-related activity. These ad-hoc requests can allow the network system to be accessed by freelancers (“gig workers”), subject to certain limitations, to facilitate performance of specific retail requests without granting third-party access to activities that involve assembly and verification of the advertising displays. As an example, a request could be made to third-party users of the Public app to capture images and/or videos from Wal-Mart store #100 that coincide with a specific date and timeframe, where the time and location can be automatically confirmed within the network system based on the geofence capabilities. This requested information could be useful in determining the performance and effectiveness of advertising campaigns, and monetary or other compensation (e.g., free or discounted products) may be provided to a third-party user if their submitted media satisfied the request. A feature to effect payment or other compensation from the requesting party to the gig-worker can be customizable within the Public app infrastructure using known networked transactional systems and methods.

The present disclosure has been generally described in terms of distinct apps (Admin, Retail, and Public), where each app is designed to be used by a different category of user. In further embodiments, a single version of the network system app can be provided and distributed to all users, with the displayed and available app features determined by the status of each registered user account. For example, registered retail users may only be provided with access to activities and functions related to their specific retail location, whereas administrators may be granted much broader app permissions to enable access to features associated with project management and overview, multiple retail sites, etc. Account-based access limitations for a single app can simplify the development and usage of the disclosed system, and may further provide more flexibility in providing app features to different users. For example, account-based limitations can provide a retail user who is a regional manager or the like with the ability to access project activities for several retail locations under their supervision, while forbidding full access to control and verification features of the overall project. In some embodiments, the Retail and Admin apps may be combined into such a permission-based app, whereas the Public app may be created and distributed to third parties as a more focused or limited application, with a set of features focused on the third-party activities described herein.

The foregoing merely illustrates the principles of the exemplary embodiments of the present disclosure, including general features and organization of the network system and associated apps, and the various features provided to and used by end users. Many specific examples are described to illustrate the various features and functions of the network system and associated apps. Other variations and combinations of these exemplary embodiments, and the application of the general features and functions described herein to achieve other results and/or effects, can be understood and effected by those skilled in the art in practicing the disclosed systems and methods from a study of the drawings and the present disclosure. The mere fact that certain features are described in different paragraphs and/or illustrated in different figures does not indicate that any combination of these features cannot be used advantageously. Various modifications and alterations to the described exemplary embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the present disclosure.

What is claimed is:

1. A system for providing status information and verification relating to installing a retail display at a retail location, comprising:
a server equipped with a processor, non-volatile computer-readable memory, and a network interface, and having a database stored in the non-volatile computer-readable memory which contains data for defining at least one retail display project, at least one retail location associated with the at least one project, and data indicating a status of the at least one project at the at least one location; and
at least one software application provided in a second non-volatile computer-readable memory and distributable to a plurality of computing devices, each of which is equipped with a display, an input device, and a further non-volatile computer-readable memory capable of storing a copy of said at least one software application, wherein the copy of said software application, when installed in the further non-volatile memory, provides instructions to a further processor associated with each of the plurality of computing devices, wherein the plurality of computing devices are configured to communicate over a network with the server;
wherein the server is configured to:
store data identifying at least one administrative account and at least one retail account associated with the at least one software application;
receive, from the at least one administrative account via the at least one software application, data defining the at least one project;
receive, from the at least one administrative account and from the at least one retail account, via the at least one software application, data relating to the status of the at least one project;
and
providing to the plurality of computing devices at least a portion of said data relating to the status of the at least one project for displaying on the plurality of computing devices, wherein the particular portion of said data provided to a particular one of the plurality of computing devices is based on whether the particular one of the plurality of computing devices is associated with an administrative account or a retail account;
wherein at least one of the plurality of computing devices associated with a retail account comprises a mobile device having image capture functionality and location awareness functionality:
wherein the at least one software application is configured to:
prompt a user of the mobile device associated with the retail account to capture an image of the retail display on the mobile device after installation of the retail display is completed at the at least one retail location, wherein the image is superimposed on a standard image of the retail display provided by the at least one software application and displayed on the mobile device while the image is being captured;
compare, using automated image comparison algorithms, the captured image with the standard image;
detect a location of the mobile device when the image was captured; and
if the comparison of the captured image with the standard image exceeds a predetermined threshold and the detected location of the mobile device is within a predetermined geofence associated with the at least one retail location, then provide data to the server indicating that the installing of the retail display at the retail location is satisfactorily completed.

2. The system of claim 1, wherein the data for defining the at least one retail display project comprises a particular retail location, a particular retail display to be installed at the particular retail location, and the geofence associated with the particular retail location.

3. The system of claim 2, wherein the server is further configured to receive shipping status information for the particular retail display, and
the at least a portion of said data relating to the status of the at least one project comprises the shipping status information.

4. The system of claim 3, wherein the server is further configured to provide time-based alerts to at least one of the at least one administrative account or the at least one retail account based at least in part on the shipping status information for the particular retail display.

5. The system of claim 1, wherein the at least one software application is further configured, if at least one of the comparison of the captured image with the standard image fails to exceed the predetermined threshold, or the detected location of the mobile device is not within a predetermined geofence associated with the at least one retail location, to prompt the user of the mobile device associated with the retail account to capture a further image of the retail display on the mobile device for comparison of the further captured image with the standard image and a further location of the mobile device detected when capturing the further image with the predetermined geofence to assess whether the installing of the retail display at the retail location is satisfactorily completed.

6. The system of claim 1, wherein the at least one software application is further configured, if at least one of the comparison of the captured image with the standard image fails to exceed the predetermined threshold, and the detected location of the mobile device is within a predetermined geofence associated with the at least one retail location, to prompt the user of the mobile device associated with the retail account to send the captured image of the retail display to an administrative account associated with the project to facilitate manual verification of the satisfactory installing of the retail display.

7. The system of claim 1, wherein the at least one software application comprises a administrative application and a retail application;
wherein the administrative application is provided to a subset of the plurality of computing devices that are associated with an administrative account; and
wherein the retail application is provided to a further subset of the plurality of computing devices that are associated with a retail account.

8. The system of claim 1, wherein the at least one software application comprises a third-party application;
wherein the server is further configured to:
store data identifying at least one third-party account associated with the third-party application, wherein the at least one third-party account is associated with a further mobile device; and
prompt a user of the further mobile device associated with the at least one third-party account to capture a third-party image of the retail display on the further mobile device after satisfactory installation of the retail display is completed at the at least one retail location, wherein the third-party image is superimposed on a standard image of the retail display provided by the third-party application and displayed on the further mobile device while the third-party image is being captured;
compare, using automated image comparison algorithms, the captured third-party image with the standard image;
detect a location of the further mobile device when the third-party image was captured; and
if the comparison of the captured third-party image with the standard image exceeds a predetermined threshold and the detected location of the further mobile device is within a predetermined geofence associated with the at least one retail location, then provide a reward to the third-party account.
